(19) United States
(12) Patent Application Publication
(10) Pub. No.: US 2004/0203380 A1
(43) Pub. Date: Oct. 14, 2004

(54) Method and wireless terminal for generating and maintaining a relative positioning system

(76) Inventors: Maher Hamdi, Le Grand-Saconnex (CH); Srdan Capkun, Lausanne (CH); Martin Vetterli, Grandvaux (CH); Jean-Pierre Hubaux, Preverenges (CH)

Correspondence Address: BLANK ROME LLP, 600 NEW HAMPSHIRE AVENUE, N.W., WASHINGTON, DC, 20037, US

(21) Appl. No.: 10/334,110

(22) Filed: Dec. 31, 2002

Related U.S. Application Data
(63) Continuation of application No. PCT/EP01/07552, filed on Jul. 2, 2001.
(60) Provisional application No. 60/215,839, filed on Jul. 3, 2000.

(51) Int. Cl. H04B 5/00; H04Q 7/20

(52) U.S. Cl. 455/41.2; 455/456.1

(57) ABSTRACT

A method for determining the relative position of wireless terminals (1) in an ad hoc network, wherein at least some of said wireless terminals can communicate over wireless links (2) in one or several hops with at least some of the other wireless terminals. The following steps are performed in the wireless terminals: (1) measuring in a plurality of said wireless terminals the distances (dᵢⱼ) to one-hop neighbors, and (2) using the distances measured in at least two wireless terminals to compute the location (x, y) of at least one other wireless terminals. One advantage of the invention is GPS-less positioning in ad hoc networks.

### FIELD OF THE INVENTION

The present invention relates to a method for determining the relative position of wireless terminals in a network. More specifically, the present invention relates to a method for determining without GPS the relative position of wireless terminals in a mobile ad hoc network, wherein at least some of said wireless terminals can communicate in one or several hops with at least some of the other wireless terminals.

Related Art

In conventional wireless personal communication systems (GSM, UMTS, AMPS etc.), the terminals (mobile stations) communicate over the air interface with so-called base stations. The base stations are in fact the gateway between wireless terminals and the wireline backbone. This solution is widely spread today, providing voice and data access to hundreds of millions of nomadic users worldwide. Several projects have been launched during the past few years in which the base stations are replaced by satellites, allowing coverage even in remote areas.

A problem with this approach is that it is fully dependant on the availability of a fixed infrastructure. This infrastructure has a number of drawbacks:

it is slow to deploy;

it is deployed only when and where it makes economic sense;

it can be rendered useless in a matter of seconds (disasters, crashes) or hours (war);

it can be under the control of an authoritarian government or of an untrusted private company.

Over the last years, ad hoc networks have captured a lot of attention from the research community. A document investigating large area wireless mobile networks referred to as mobile ad hoc wide area networks is described by J.-P. Hubaux et al. in “Towards Mobile Ad-Hoc WANs: Terminodes, Technical Report”, DSC/2000/006, EPFL-ICA, February 2000.

In ad hoc networks, the wireless terminals are able to relay communications on behalf of other ones. In particular, radically distributed networks in which most or even all networking functions are embedded in the terminals themselves are already known. Such wireless terminals which are empowered with routing capabilities are sometime called terminodes or mobile switches (mobile hubs).

In an ad hoc network, wireless terminals can communicate directly with each other. If the wireless terminals are too far from each other, then the communication will be relayed over intermediate terminals. Some terminals may be able to forward a communication to a backbone network or to a satellite network. Other terminals may also play the role of information servers and in this way play the role of the current Web servers in IP networks.

As ad hoc networks are not centrally managed, the wireless terminals must have the ability to learn their environment. In order to forwards packets received from other wireless terminals, each terminal which acts as a relay must be able to learn at least a part of the —usually changing—network topology. This topology can change when terminals move or when new terminals log into or out of the network.

US5737318 describes a method for automatically initializing a wireless, packet-hopping network, in this case a building system control network which is used to control the operation of a building system. In accordance with this method, each node in the network first determines its connectivity to every other node in the network and then routes this connectivity to a central computer in the building. US5412654 describes another method for computing and actualizing routing tables in terminals of an ad hoc network.

These methods only allow to determine the logical network topology, i.e. the set of nodes and of connecting links between those nodes. Knowledge of the network topology is needed in order to route packets and communications between nodes. The geographical position of the nodes remains unknown.

DE19733586 describes a location-aided routing method in an ad hoc network in which the position of each terminal is determined with a GPS-receiver (Global Positioning System). This knowledge is used in order to route communications and forward packets in the geographical direction of the receiver. In this method, each terminal knows not only the logical topology of the network, but also at least part of its geographical topology. Similar location-based routing devices are described in DE19849294 and WO99/46899, and by Y. Ko et al. in “Location-Aided Routing (LAR) in Mobile Ad Hoc Networks”, Mobicom 98, Dallas, pages 66-74.

Using GPS receivers for determining the location of the terminals however has a number of drawbacks:

GPS receivers tend to be expensive.

Their power consumption is important for portable equipments, especially for miniaturized equipments with a small battery, or when the battery can not easily be recharged or replaced.

The precision is limited and can be restricted.

They are useless in GPS-blind areas, for example inside most buildings.

Positioning services in cellular mobile systems have drawn much attention recently following a US FCC regulation for locating E911 callers. The new regulations introduce stringent demands on the accuracy of mobile phone location. The FCC requires the wireless operators to locate the position of emergency callers with a root means square error below 125m, by October 2001. Solutions to this requirement are described by J. Caffery et al. in “Overview of Radiolocation in CDMA Cellular Systems”, IEEE Communications Magazine, pages 38-45, April 1998, and by M. Silventoinen et al. in “Mobile Station Emergency Locating in GSM”, ICPWC 1996, pages 232-238.

There are no methods known at the moment that allow such a precision to be reached in ad hoc network without GPS receivers.

An aim of the invention is therefore to propose a new system and method for generating and maintaining a relative positioning system in an ad hoc network that avoids the drawbacks of the prior art.

Another aim of the invention is to provide a new method for locating wireless terminals in an ad hoc network that does not rely on GPS, nor on any other available beacons.

Another aim of the invention is to find a way to obtain the position of the terminals in an ad hoc network by distributed processing, and to find a method that enables the terminals to find their positions within the network area using only the locally available information.

Another aim of the invention is to find a way to obtain position of terminals in the scenarios where infrastructure does not exist and GPS cannot be used.

### BRIEF SUMMARY OF THE INVENTION

According to the invention, those technical problems are solved with a new self-positioning algorithm (SPA) and method.

More specifically, those problems are solved with a positioning method using range measurements between terminals to build a global coordinate system. The new method preferably comprises the following steps performed in a plurality of wireless terminals (i):

measuring the distances between said wireless terminals and their respective one-hop neighbors,

using said distances to compute the location of at least some of said wireless terminals in a global coordinate system used by a plurality of said wireless terminals.

The invention has the advantage over existing positioning methods that it does not rely on the deployment of any infrastructure. Relative positions can be computed as soon as the density of nodes in an area is high enough.

The invention can be applied in the scenarios where the location information is used to support basic network functions. Two examples of this kind of applications are location-aided routing and geodesic packet forwarding. The use of the method is however not limited to routing applications only. Other user-specific services can profit in quality and additional services can be defined. In particular, the method can be used to increase safety (e.g. mutual positioning of the members of a squad of firefighters in a large building, whereas the absolute coordinate of each firefighter may be computed if at least three terminals include a GPS-receiver).

### DESCRIPTION OF THE DRAWINGS

The invention will be better understood with the help of the following description, given as an example, and illustrated by the figures in which:

FIG. 1 illustrates a network of wireless terminals with the known distances between pairs of terminals.

FIG. 2 illustrates the same network with a coordinate system in which the location of the wireless terminals can be computed.

FIG. 3 shows how the local coordinate system used by a specific wireless terminal can be generated.

FIG. 4 is a diagram showing the way to obtain the position of an arbitrary node j in the coordinate system of node i.

FIG. 5 shows the various local coordinate systems used by different wireless terminals in the network.

FIG. 6 is a diagram showing the coordinate systems of two neighbor wireless terminals i and k.

FIG. 7 illustrates the possible directions of the coordinate systems to wireless terminals after the rotation of one coordinate system.

FIG. 8 shows how the position of an arbitrary wireless terminal can be computed when the local coordinate systems are equally oriented.

FIG. 9 illustrates the notion of location reference group in a network.

FIG. 10 shows the reconstruction of the coordinate system C1 in the coordinate system C2.

### DETAILED DESCRIPTION OF THE INVENTION

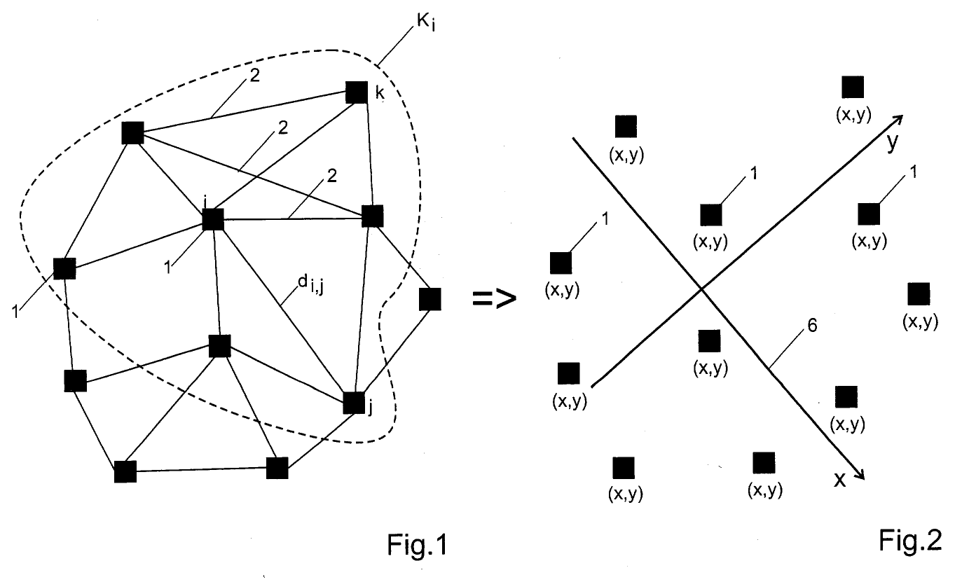

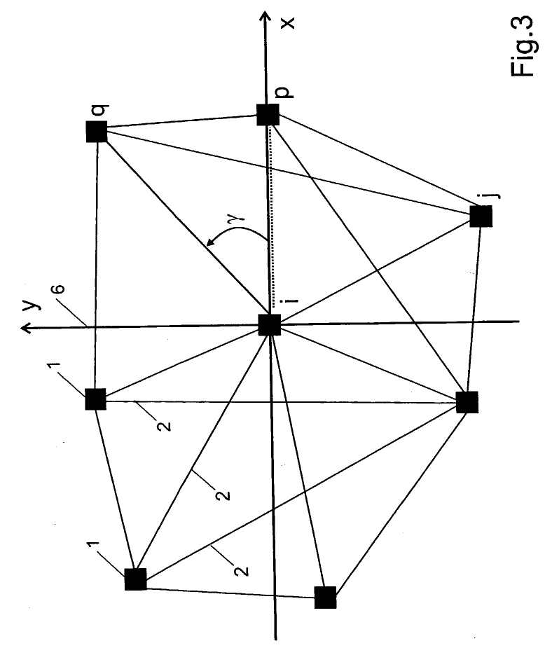

FIG. 1 shows an ad hoc network comprising a plurality of nodes i, j, k etc. The nodes are constituted by wireless terminals 1. In the following, we will use the terms nodes and wireless terminals interchangeably. Neighbor nodes are connected by wireless links 2 shown as lines in the figure. The distances dᵢⱼ between at least some neighbor nodes can be measured by the wireless terminals 1. FIG. 2 shows the same network with a coordinate system 6×, y in which the coordinates (xᵢ, yᵢ) of at least some terminals will be computed.

At least some wireless terminals 1 are mobiles. The topology of the network may be constantly changing, although in many applications at least some wireless terminals may be stable for longer periods. At least some of the wireless terminals 1 comprise electronic circuit means (not shown) for communicating over the wireless interface with similar wireless terminals and for relaying communications on behalf of other wireless terminals, as well as distance measuring means for measuring the distance to other wireless terminals in the neighborhood. The wireless terminals 1 may comprise for example:

Small wireless personal devices used for voice and/or data communication between users, for example mobile phone, palmtops, laptops, personal digital assistants etc.

Sensors for measuring and transmitting physical parameters, for example for measuring displacements in a civil engineering work.

RFID devices.

Bluetooth, HomeRF or 802-11 wireless terminals in a short range wireless LAN.

Sensors used in the car industry for vehicle cooperation.

Etc.

whereas different kind of wireless terminals can be combined in a same network.

The wireless links 2 between wireless terminals preferably use unlicensed frequencies, for example in the 433 MHz or 2.4 GHz range. In a preferred embodiment, at least some links use a non-proprietary short-range protocol, for example Bluetooth, HomeRF or 802.11. The wireless terminal j is called a one-hop neighbor of node i if i and j can communicate directly (in one hop). At least some wireless terminals may act as switches for relaying communications between wireless terminals that are out of range and cannot communicate directly. An incentive mechanism may be used in order to let the terminal users make their device be used as a switch for relaying others' communications.

We define ∀i ε N a set of nodes Kᵢ such that ∀j ε Kᵢ, i≠j, dᵢⱼ≦min (Pi, Pj), where N is the set of all the nodes in the network, dᵢⱼ is the distance between nodes i and j and Pi, Pj are the power range of the nodes i and j respectively. We call Kᵢ the set of one-hop neighbors of node i. We define ∀i ε N the set Di as a set of distances measured from the node i to the nodes j ε Kᵢ. The neighbors can be detected by using beacons. After the absence of a predetermined number of successive beacons, it is concluded that the node j is no longer a neighbor of i.

At least some wireless terminals 1 comprise distance measuring means for measuring the distance to one-hop neighbors. The distance dᵢⱼ is obtained by measuring at least one characteristic of one signal exchanged between the wireless terminal i and the wireless terminal j. In a preferred embodiment, allowing for a good precision, distances are measured by using the time of flight of said signal. The distance may also be measured with other methods, for example by measuring the attenuation of the signal. Other wireless terminals may miss those distance measuring means and do not help to compute the topology of the network, although their own position may be computed from measures made by other wireless terminals.

Distance measurements between wireless terminals may be corrupted by two types of errors: Non-Line of Sight (NLOS) error and measuring error, Measurements have shown that NLOS error tends to be the main cause of the error in range estimation. They also show that the location estimation error linearly increases with the distance error. This error can be detected and corrected using the method described by Wylie and Holtzmann in “The non-line of sight problem in mobile location estimation”, 5^{th} IEEE International Conference on Universal Personal Communications, 1996, pages 827-831. Using the standard deviation of the measurement noise and the history of the range measurements can reduce the error. Moreover, the location error can be reduced by using the Residual Weighting Algorithm (Rwgh) described by P. C. Chen in “A non-line-of-sight error mitigation algorithm in location estimation”, 5^{th} IEEE International Conference on Universal Personal Communications, 1996, pages 316-320. This method proposes to correct the location estimation errors by using a greater number of range measurements than the minimum required (redundancy).

In a preferred embodiment, during initialization, the following procedure is performed at every node i:

detecting all one-hop neighbors (Kᵢ) of node i

measuring the distances to one-hop neighbors (Dᵢ)

sending the Kᵢ and Dᵢ to all one-hop neighbors.

Thus every node knows its two-hop neighbors and some of the distances between them. A number of distances cannot be obtained due to power range limitations.

By choosing nodes p, q in the set Kᵢ such that the distance between p and q (d_{pq}) is known and larger than zero, node i defines its local coordinate system 6. The situation is illustrated with FIG. 3. Node p lies on the positive x axis of the coordinate system and node q has a q_{y} component that we define as being positive. This way the coordinate system with the center in node i is uniquely defined.

Thus, the coordinates of the nodes i, p and q are

iₓ=0, i_{y}=0

pₓ=dᵢₚ, p_{y}=0

qₓ=d_{iq} cosγ, q_{y}d_{iq} sinγ

where γ is the angle ∠(p, i, q) in the triangle (p, i, q) and is obtained by using a cosines rule for triangles

γ=arccos(d²_{iq}+d²ᵢₚ−d²_{pq})/2d_{iq}dᵢₚ

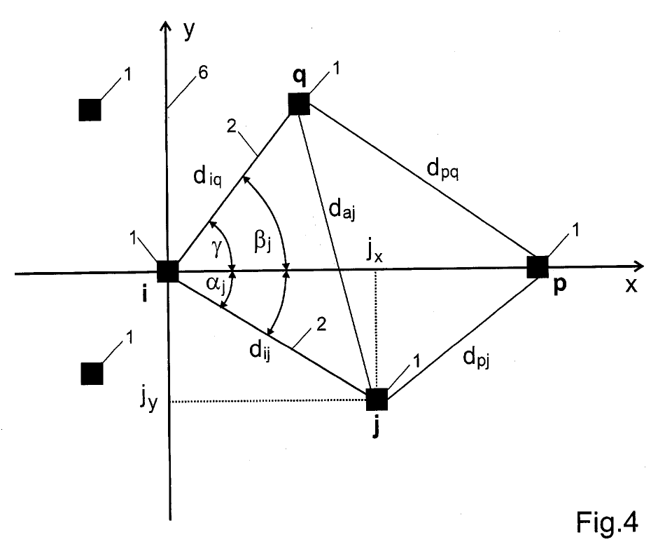

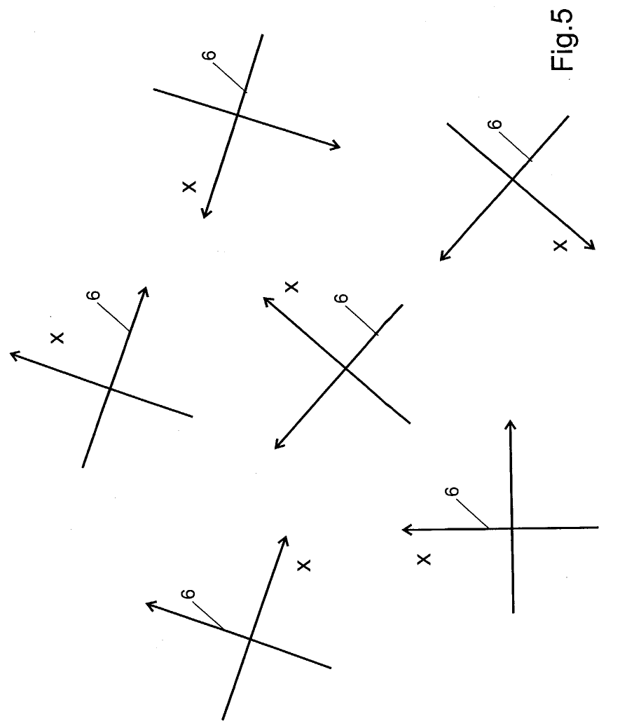

The positions of the terminals j in the set Kᵢ, j≠p,q for which the distances dᵢⱼ, d_{qj}, dₚⱼ are known are computed by triangulation. The situation is illustrated with FIG. 4. The position of the node j is obtained by solving the following system of equations

(jₓ−iₓ)²+(j_{y}−i_{y})²=d²ᵢⱼ

(jₓ−pₓ)²+(j_{y}−p_{y})=d²ₚⱼ

(jₓ−qₓ)²+(j_{y}−q_{y})²=d²_{qj}

Therefore, we obtain

jₓ=dᵢⱼ cosαⱼ

if βⱼ=¦αⱼ−γ¦ then j_{y}=dᵢⱼ sinαᵢ,

else j_{y}=−dᵢⱼ sinαⱼ

where αj is the angle ∠(p, i, j) in the triangle (p, i, j), βj is the angle ∠(j, i, q) in the triangle (j, i, q) and γ is the angle ∠(p, i, q) in the triangle (p, i, q).

The positions of the nodes j in the set Kᵢ, j≠p, q, which are not the neighbors of nodes p and q can be computed by using the positions of the node i and at least two other nodes for which the positions are already obtained, if the distance from the node j to these nodes is known.

Limited power ranges of the wireless terminals 1 reduce the number of one-hop neighbors for which node i is able to compute the position. We define a local view set (LVS) for node i as a set of nodes LVSᵢ⊂ Kᵢ such that ∀j ε LVSᵢ, node i can compute the location of node j, given that the node i is the center of the coordinate system 6. By choosing different ps and qs for the same node i we obtain different local view sets. The choice of p and q should maximize the number of nodes for which we can compute the position.

After the nodes have built their local coordinate systems 6, their positions are set to (0,0) and their coordinate systems have different directions, as illustrated in FIG. 5. A direction is defined as a set of two axis vectors x, y. We will now describe a way to adjust the directions of the local coordinate systems 6 to obtain the same direction for all the nodes in the network. We call this direction the direction of the network global coordinate system. We will then describe a preferred method for electing the center of the global coordinate system. Finally, we will show the way to compute the positions of the nodes in the network global coordinate system.

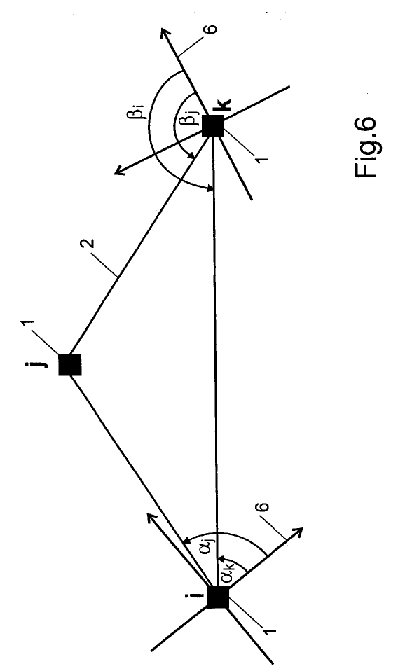

FIG. 6 shows two neighbors nodes, i and k. To adjust the direction of the coordinate system 6 of the node k to have the same direction as the coordinate system of the node i, node k has to rotate and possibly mirror its coordinate system. We denote this rotation angle as the correction angle for the node k. To obtain the correction angle two conditions have to be Net:

Nodes i ε LVSₖ and k ε LVSᵢ

∃j such that j ε LVSₖ and j ε LVSᵢ

The following procedure is performed at the nodes to detect possible symmetry of the local coordinate systems of the nodes i and k:

Node k rotates its coordinate system 6 in the positive direction by angle αj

Node i rotates its coordinate system 6 in the positive direction by angle βᵢ

Nodes i and k compare the positions of the node j in the coordinate systems 6 of i and k to detect the symmetry where αₖ is the angle of the vector \vec{i}k in the coordinate system of the node i and βi is the angle of the vectors \vec{k}i in the coordinate system of the node k.

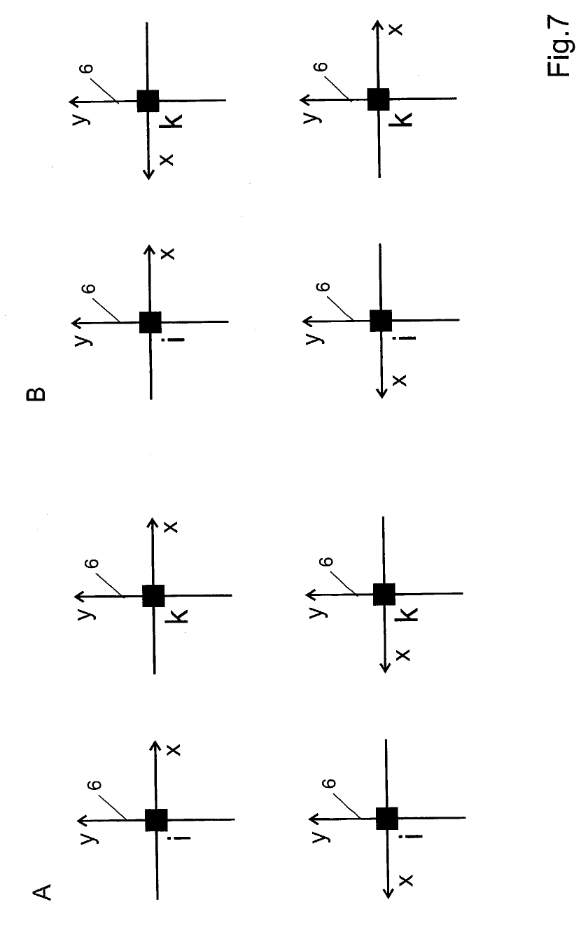

After the rotation, the axes of the local coordinate systems 6 of the nodes are parallel, but the coordinate systems are not necessarily equally oriented. FIG. 7 illustrates the possible directions of the coordinate system of the nodes i and k after the rotation.

It can be seen that:

if αⱼ−αₖ<π and βⱼ−βᵢ<π

or αⱼ−αₖ>π and βⱼ−βᵢ>π

[symbol] the coordinate systems are symmetrical

[symbol] they mirror the coordinate system of k ∀n εεLVSₖ, nₓ=−nₓ

[symbol] the correction angle=Pk−i

if αⱼ−αₖ<π and βⱼ−βᵢ>π

or αⱼ−αₖ>π and βⱼ−βᵢ<π

[symbol] the coordinate systems are not symmetrical

[symbol] the correction angle=βₖ−αᵢ+π

Note that the angles αⱼ and αₖ are equally oriented, thus the difference between them can only be positive. The same is valid for the angles βⱼ and βᵢ.

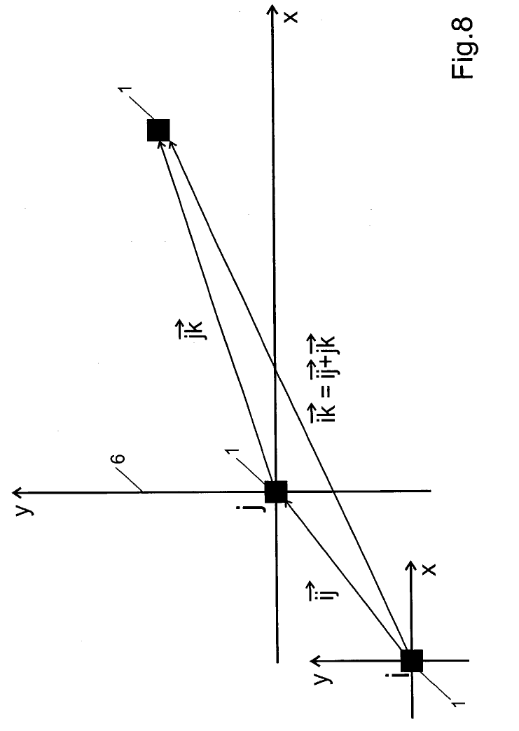

In FIG. 8, we observe the nodes i, j and k with the same direction of the local coordinate systems. Node j is a neighbor of the nodes i and k, but nodes i and k are not neighbors. To compute its position in the coordinate system of the node i, node k has to know its position in the coordinate system of the node j and the position of node j in the coordinate system of the node i. As the coordinate systems are equally oriented, the position of the node k in the coordinate system of the node i is obtained by adding of vectors. Thus,

\vec{i}k=\vec{i}j+\vec{j}k

In this section we describe a preferred method to define the center and the direction of the network coordinate system.

One possible approach to this problem is to elect a local coordinate system 6 of one of the nodes in the network to be the coordinate system of the network. The mobility of this node would then cause considerable inconsistency between the real and computed positions of the nodes. This approach can be used in small area networks where the nodes have low mobility and where the disconnections of the nodes are not expected. A possible solution would be to choose a fixed node, if there is one such, or at least a slowly moving node. A more stable, but in terms of message broadcast very costly approach is to compute the center of the coordinate system as a function of the positions of all the nodes in the network. In this case, the network coordinate system center is the geometrical center of the network topology and the direction of the coordinate system is the mean value of the directions of the local coordinate systems of the nodes. In this approach, it is assumed that the node which performs the computation of the center and the direction of the network coordinate system has knowledge of the global network topology.

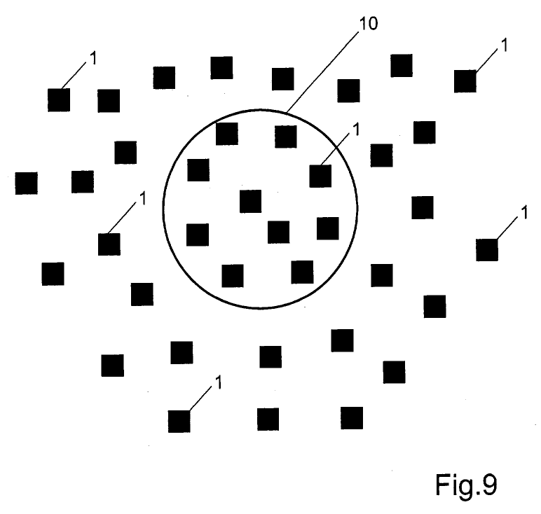

In a variant embodiment, a set of nodes called location reference group LRG c N is defined such that the density of the nodes in the LRG is the highest in the network. An example of location reference group 10 is illustrated in FIG. 9. As the location reference group is a smaller set than N, the location reference group center can be computed with less cost expenditure than the center of the entire network. The network center is not a particular node, but a virtual point, whose position depends on the topology of the location reference group. Broadcast is used to obtain the location reference group topology. When the nodes are moving, the location reference group center is re-computed accordingly. We expect the average speed of the group center to be less than the average speed of the nodes. This way, we stabilize the center of the network and reduce the inconsistency. The direction of the network coordinate system is computed as the mean value of the directions of the local coordinate systems of the nodes in the LRG. The larger the location reference group, the more stable it is, but it becomes more difficult to maintain and more costly to compute the center and the direction of the network coordinate system. In order to initialize the location reference group, every node performs the following computations:

Broadcasting initializing packets (for example hello-messages) to its n-hop neighborhood to obtain the node IDs, their mutual distances and the directions of their coordinate systems. The number n depends on stability requirements and available processing power.

Computing the positions of the n-hop neighbors in its local coordinate system.

Computing the n-hop neighborhood center as:

$${c}_{x} = \frac{\sum {j}_{x}}{m}$$

$${c}_{y} = \frac{\sum {j}_{y}}{m}$$

where m is the number of nodes in the n-hop neighborhood and jₓ and j_{y} are the x and y coordinates of the nodes, respectively.

Computing the n-hop neighborhood direction angle as the average of all the local coordinate center directions.

Computing the density factor as a function of the number of nodes and the distances to the nodes in its n-hop neighborhood.

Once the node computes these parameters, it broadcasts the density factor, the information about the center and the direction of the n-hop neighborhood to its neighbors. The nodes with the lower density factor will be slaved by the node with the higher density factor and will compute positions in the coordinate system of this node. The directions of their coordinate systems will be adjusted accordingly. This way, the network will adopt a unique coordinate system. The node with the highest density factor in the network is called the initial location reference group master and the nodes for which it can obtain the location information in its n-hop neighborhood are called the initial location reference group. The nodes belonging to the location reference group maintain the list of nodes in the location reference group.

Due to the node mobility of the nodes, the location reference group members will change position and the center of the group will change. To update this change regularly, the following method can be performed by the members of the location reference group:

Broadcasting the hello package to its n-hop neighborhood to obtain the node IDs, their mutual distances and the directions of their coordinate systems.

Comparing the n-hop neighbors list with the list of the location reference group members.

The node which has the n-hop connection with the location reference group master and the highest number of location reference group members still in its n-hop neighborhood is elected to be the new location reference group master and its n-hop neighbors for which it can obtain the initial location information become the new location reference group. This way, the stability of the center is achieved.

If the node does not have the location reference group master in its n-hop neighborhood, it starts an initialization timer. If within some time the node does not receive the new position information issued by the LRG master, it starts the initialization procedure.

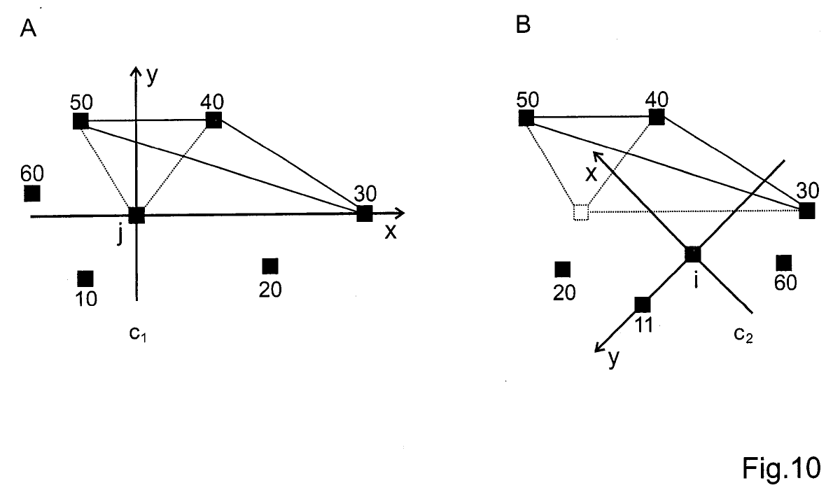

As the positions of the nodes p and q are random, the directions of the local coordinate systems are also random. This makes the direction of the network coordinate system random, as it depends only on the directions of local coordinate systems in the location reference group. We propose the scheme illustrated in FIG. 10 to stabilize the direction of the networks coordinate system, by stabilizing the directions of the local coordinate systems of the nodes belonging to the location reference group:

The node j chooses the direction (p, q) of the coordinate system and computes the positions of the neighbors coordinate system. We note this coordinate system as C1.

When rerunning the local coordinate system algorithm, the node j chooses the new (p and q) and computes the positions of the nodes in the new coordinate system. We note this coordinate system as C2.

It compares the positions of the nodes in the two coordinate systems and searches for the maximum set of nodes (at least 3), which has the same topology in both C1 and C2. From this, we conclude that the nodes 30, 40, 50 belonging to this set did not move during the time between two algorithms running. This statement is not certain, but it is true with very high probability.

We use this set of nodes 30, 40, 50 and their distances to reconstruct the center of the C1 in the coordinate system C2. This allows us to adjust direction of C2 to the orientation of C1. If the node cannot reconstruct the coordinate system, it keeps the direction of C2.

This algorithm allows every node to introduce direction stability in its coordinate system. The location reference group master computes the direction of the network coordinate system as the average direction of the nodes in the location reference group. Therefore, this algorithm stabilizes the direction of the network coordinate system. In the high density area, such as in the location reference group, we expect to have a low mobility set which will enable this algorithm to be used. An example of the coordinate system reconstruction is shown in FIG. 10.

If at least three absolute positions are known in the global coordinate system, one may then be able to compute the absolute position of all terminals 1 in the network.

1. A method for determining the relative position of wireless terminals in an ad hoc network in which at least some of said wireless terminals can communicate over wireless links in one or several hops with at least some of the other wireless terminals and the location of at least one wireless terminal is determined by measuring the distances between at least two terminals, the method comprising:
measuring in a plurality of said wireless terminals the distances to one-hop neighbors,
sending measured distances to other wireless terminals, and
using the distances measured in at least two terminals to compute in at least one said wireless terminal the position of at least one other wireless terminal.

2. The method of claim 1, wherein said distances between said wireless terminals and their one-hop neighbors are measured from at least one characteristic of one signal transmitted between said wireless terminal and said neighbor.

3. The method of claim 2, wherein said characteristic is the time of arrival of said signal.

4. The method of claim 2, wherein said characteristic is the attenuation of said signal.

5. The method of claim 3, wherein the number of distances measured is greater than the minimum required in order to compute said locations, this redundancy being used for improving the precision with which the location can be determined.

6. The method of claim 1, wherein a history of positions of at least one wireless terminal is stored, said history being used for improving the precision with which the location can be determined.

7. The method of claim 3, wherein each wireless terminal computes the location of a different set of wireless terminals in the network.

8. The method of claim 7, wherein each wireless terminal uses a different local coordinate system in which it computes the location of said set of wireless terminals.

9. The method of claim 8, further comprising a step of choosing a global coordinate system and communicating said global coordinate system to all wireless terminals over said wireless links.

10. The method of claim 8, wherein said local coordinate system is computed in at least some of said wireless terminals by:
detecting all one-hop neighbors of said wireless terminal,
measuring the distance to said one-hop neighbors,
receiving the distance between at least some pairs of said one-hop neighbors,
choosing two neighbors such that the distance between said neighbors is known and larger than zero, and
using said two neighbors to define the local coordinate system of said wireless terminal.

11. The method of claim 9, further comprising a step of translating said location into said global coordinate system.

12. The method of claim 11, wherein the local coordinate system of one of said wireless terminals is elected as global coordinate system and communicated to the other wireless terminals.

13. The method of claim 12, wherein the wireless terminal whose local coordinate system is elected is a fixed wireless terminal.

14. The method of claim 9, wherein the wireless terminal having the lowest speed is determined, the local coordinate system of said wireless terminal being elected as a global coordinate system.

15. The method of claim 9, further comprising:
selecting a reference group of N wireless terminals, wherein the number N of wireless terminals in the group is lower than the total number of wireless terminals in the network,
defining a global coordinate system depending on the position of said wireless terminals within said reference group, and
communicating said global coordinate system to wireless terminals outside said reference group.

16. The method of claim 15, wherein said reference group is selected such that the density of wireless terminals is the highest in the network.

17. The method of claim 9, further comprising a step of recomputing said global coordinate system to adapt it to changes in the topology of the network.

18. The method of claim 2, said method comprising indicating the absolute position of at least three wireless terminals in said network, in order to be able to compute the absolute position of at least one other wireless terminal.

19. The method of claim 2, wherein said wireless terminals communicate with each other over a short range radio protocol, for example Bluetooth, HomeRF or 802.11.

20. The method of claim 1, further comprising a step of routing packets in at least one of said wireless terminals based on its knowledge of its own location and one of that of other wireless terminals.

21. The method of claim 1, wherein said wireless terminals are mobile personal communication devices, said method further comprising a step of exchanging data or voice data with a cellular mobile phone network.

22. The method of claim 1, wherein at least some of said wireless terminals are incorporated in cars, said method further comprising a step of displaying to a driver the distance to another car.

23. The method of claim 1, wherein at least some of said wireless terminals are made of interconnected sensors, said method further comprising a step of detecting the sensors' displacements.

24. A wireless terminal comprising:
electronic circuit means for directly communicating over a wireless interface with similar wireless terminals and for relaying communications on behalf of other wireless terminals,
distance measuring means for measuring the distance to other wireless terminals, and
computing means for computing the position of at least one other wireless terminal, said location being computed based on said distances and on distance information received from other wireless terminals.

25. The wireless terminal of claim 24, wherein said distances are measured by measuring at least one characteristic of one signal exchanged with said other wireless terminal.

26. The wireless terminal of claim 25, wherein said characteristic is the time of arrival of said signal.

27. The wireless terminal of claim 24, wherein said characteristic is the attenuation of said signal.

28. The wireless terminal of claim 24, further comprising:
means for detecting all one-hop neighbors of said wireless terminal,
receiving means for receiving the distances between at least some pairs of said one-hop neighbors,
means for choosing two neighbors such that the distance between said neighbors is known and larger than zero, and
means for using said two neighbors to define the local coordinate system of said wireless terminal.

29. The wireless terminal of claim 28, further comprising means for translating the position of a wireless terminal in said local coordinate system into a global coordinate system used by other wireless terminals.

30. The wireless terminal of claim 24, further comprising location based routing means for routing packets to another wireless terminal based on the knowledge of said location of other wireless terminals.

31. The wireless terminal of claim 24, comprising a mobile phone part.

32. The wireless terminal of claim 24, wherein said wireless terminals are made of sensors for sensing a physical parameter and sending the value measured to other wireless terminals.

33. The wireless terminal of claim 24, wherein said wireless interface uses a non proprietary short range radio communication protocol, for example Bluetooth, HomeRF or 802.11.
